(19) United States
(12) Patent Application Publication
(10) Pub. No.: US 2008/0144847 A1
(43) Pub. Date: Jun. 19, 2008

(54) APPARATUS AND METHOD FOR PLAYBACK TEST OF AN AUDIO DEVICE

(75) Inventors: AI-MIN CHEN, Shenzhen (CN); XIAO-CHENG GUAN, Shenzhen (CN); XIAO-LIN GAN, Shenzhen (CN); YU-KUANG HO, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 11/852,339

(22) Filed: Sep. 10, 2007

(30) Foreign Application Priority Data
Dec. 13, 2006 (CN) 200610157508.8

(51) Int. Cl. H04R 29/00

(52) U.S. Cl. 381/58

(57) ABSTRACT

A system and a method for playback test of an audio device. The method includes the steps of: controlling an audio analyzer (3) connected to a host computer (2) to generate analog audio signals at different sampling frequencies, different sampling bit width and different signal amplitude, and controlling the audio analyzer to output the digital audio signals to a client computer (5) connected to the audio analyzer via an analog signal output interface (310); receiving the analog audio signals and converting the analog audio signals into first digital audio signals by a first sound card (6) to be tested inside the client computer; outputting the first digital audio signals to a digital signal input interface (311) of the audio analyzer; and controlling the audio analyzer to test and analyze the digital signals received at the digital signal input interface, and producing a test result.

### BACKGROUND OF THE INVENTION

1. Field of the Invention

The present invention is related to apparatuses and methods for playback test, and more particularly to an apparatus and method for playback test of an audio device.

2. Description of Related Art

Nowadays, a computer not only assists people in processing data, but it can also be used as a multimedia player that brings music or multimedia information to people. An audio device plays an important role in transmitting audio signals within a computer. Before a computer is shipped to a customer or a computer reseller, the computer should pass a series of performance tests, such as testing the audio device to make sure that the audio device works normally.

One test for audio devices includes the steps of converting a generated analog audio signal into a waveform audio (wav) file format and converting the wav file format into an authorware shocked (aas) file format. However, partial data of the audio files is lost in the steps of format conversion.

Accordingly, what is needed is a system and method for playback test of an audio device, which can test audio files without data loss and recognize real-time analysis of test results.

### SUMMARY OF THE INVENTION

One preferred embodiment provides an apparatus for playback test of an audio device. The apparatus include a host computer, an audio analyzer connected to the host computer, and a client computer connected to the audio analyzer. The host computer is installed with an audio test program for controlling the audio analyzer to generate analog audio signals at different sampling frequencies, different sampling bit width and different signal amplitude, and controlling the audio analyzer to output the analog audio signals to the client computer via an analog signal output interface. The client computer is installed with a first sound card to be tested for receiving the analog audio signals and converting the analog audio signals into first digital audio signals. The client computer is configured for outputting the first digital audio signals to a digital signal input interface of the audio analyzer, and the audio test program controls the audio analyzer to test and analyze the digital signals received at the digital signal input interface and produce a test result.

Another preferred embodiment provides a method for playback test of an audio device. The method includes the steps of: controlling an audio analyzer connected to a host computer to generate analog audio signals at different sampling frequencies, different sampling bit width and different signal amplitude, and controlling the audio analyzer to output the digital audio signals to a client computer connected to the audio analyzer via an analog signal output interface; receiving the analog audio signals and converting the analog audio signals into first digital audio signals by a first sound card to be tested inside the client computer; outputting the first digital audio signals to a digital signal input interface of the audio analyzer; and controlling the audio analyzer to test and analyze the digital signals received at the digital signal input interface, and producing a test result.

Other systems, methods, features, and advantages will be or become apparent to one skilled in the art upon examination of the following drawings and detailed description.

### BRIEF DESCRIPTION OF THE DRAWINGS

FIG. 1 is a block diagram of hardware configuration of an apparatus for playback test of an audio device in accordance with one preferred embodiment;

FIG. 2 is a block diagram of hardware configuration of an apparatus for playback test of an audio device in accordance with another preferred embodiment; and

FIG. 3 is a flowchart of a method for playback test of an audio device in accordance with one preferred embodiment.

### DETAILED DESCRIPTION OF THE INVENTION

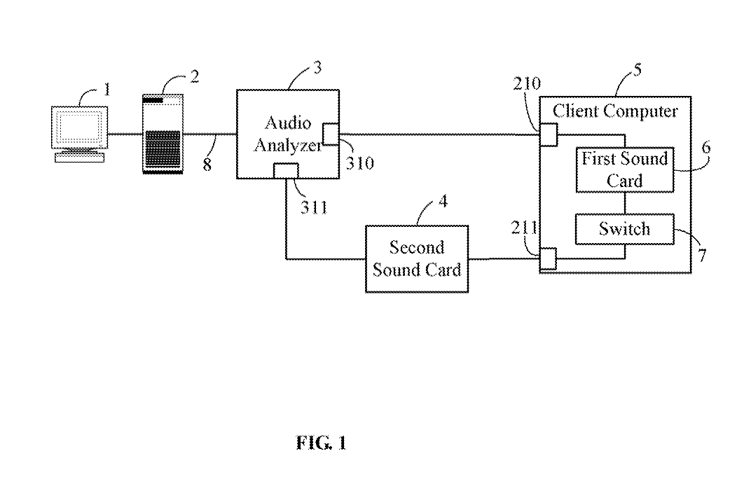

FIG. 1 is a block diagram of a hardware configuration of an apparatus for playback test of an audio device in accordance with one preferred embodiment. The apparatus typically include a host computer 2, a display 1 connected to the host computer 2, a client computer 5 having a first sound card 6 to be tested and a switch 7, an audio analyzer 3, and a second sound card 4. The host computer 2 is connected with the audio analyzer 3. The host computer 2 is installed with an audio test program that controls the audio analyzer 3 to test and analyze audio signals. The client computer 5 further includes an analog signal input interface 210, and a universal serial bus (USB) interface 211. The audio analyzer 3 includes an analog signal output interface 310 and a digital signal input interface 311. The USB interface 211 is connected with the digital signal input interface 311 via the second sound card 4.

The host computer 2 is configured for controlling the audio analyzer 3 to generate analog audio signals at different sampling frequencies, different sampling bit width and different signal amplitude. The host computer 2 is further configured for controlling the audio analyzer 3 to output the analog audio signals to the client computer 5 via the analog signal output interface 310.

The first sound card 6 of the client computer 5 is configured for receiving the analog audio signals and converting the analog audio signals into first digital audio signals.

The client computer 5 is configured for transmitting the first digital audio signals to the USB interface 211 through the switch 7 and outputting the first digital audio signals to the second sound card 4 from the USB interface 211.

The second sound card 4 is configured for converting the first digital audio signals into second digital audio signals receivable by the audio analyzer 3, and transmitting the second digital audio signals to the digital signal input interface 311 of the audio analyzer 3. The second sound card 4 is a standard sound card.

The host computer 2 is further configured for controlling the audio analyzer 3 to test and analyze the digital signals received at the digital signal input interface 311 and for displaying a test result on the display 1. Parameters of testing and analyzing the analog signals include full scale output voltage, frequency response, total harmonic distortion plus noise, dynamic range, signal to noise ratio, channel separation, passband ripple, and interchannel phase delay.

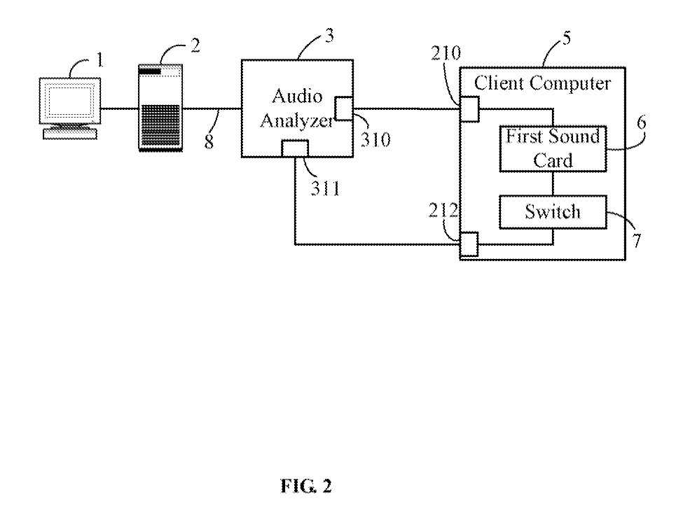

FIG. 2 is a block diagram of hardware configuration of an apparatus for playback test of an audio device in accordance with another preferred embodiment. The client computer 5 further include a digital audio signal output interface 212 connected to the digital signal input interface 311. The audio analyzer 3 can receive the first digital audio signals outputted by the client computer 5 via the digital audio signal output interface 212 and the digital signal input interface 311, instead of utilizing the second sound card 4 in the first embodiment.

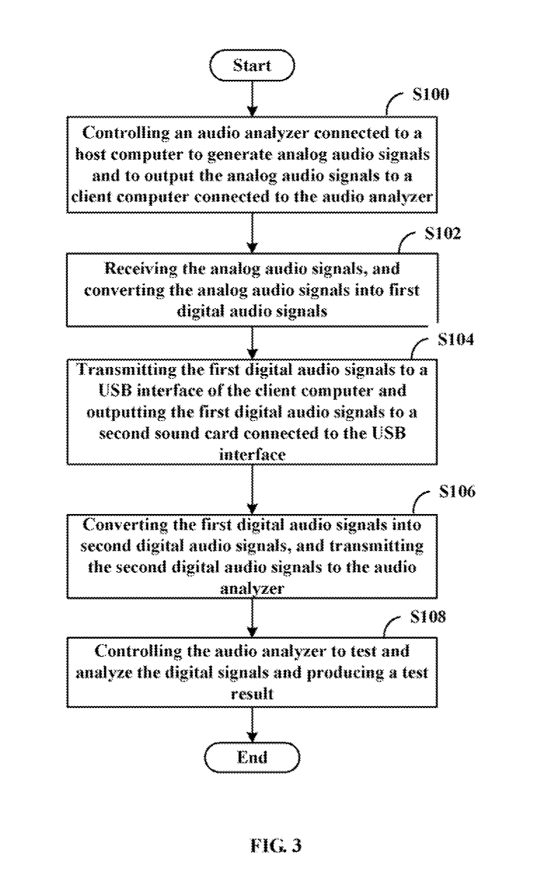

FIG. 3 is a flowchart of a method for playback test of an audio device in accordance with one preferred embodiment.

In step S100, the host computer 2 controls the audio analyzer 3 to generate the analog audio signals at different sampling frequencies, different sampling bit width and different signal amplitude, and the host computer 2 controls the audio analyzer 3 to output the analog audio signals to the client computer 5 via the analog signal output interface 310 and the analog signal input interface 210.

In step S102, the first sound card 6 inside the client computer 5 receives the analog audio signals, and converts the analog audio signals into first digital audio signals.

In step S104, the client computer 5 transmits the first digital audio signals to the USB interface 211 through the switch 7 and outputs the first digital audio signals to the second sound card 4 from the USB interface 211.

In step S106, the second sound card 4 converts the first digital audio signals into second digital audio signals receivable by the audio analyzer 3, and transmits the second digital audio signals to the audio analyzer 3 via the digital signal input interface 311.

In step S108, the host computer 2 controls the audio analyzer 3 to test and analyze the digital signals received at the digital signal input interface 311, produce a test result, and display the test result on the display 1.

In an alternative embodiment, in the step S100, the client computer 5 transmits the first digital audio signals to the digital audio signal output interface 212 through the switch 7 and outputs the first digital audio signals to the digital signal input interface 311 of the audio analyzer 3 via the digital audio signal output interface 212, and the procedure goes to step S108 directly.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. An apparatus for playback test of an audio device, comprising a host computer, an audio analyzer connected to the host computer, and a client computer connected to the audio analyzer, wherein:
the host computer is installed with an audio test program for controlling the audio analyzer to generate analog audio signals at different sampling frequencies, different sampling bit width and different signal amplitude, and controlling the audio analyzer to output the analog audio signals to the client computer via an analog signal output interface;
the client computer is installed with a first sound card, to be tested, for receiving the analog audio signals and converting the analog audio signals into first digital audio signals; and
the client computer is configured for outputting the first digital audio signals to a digital signal input interface of the audio analyzer, and the audio test program controls the audio analyzer to test and analyze the digital signals, received at the digital signal input interface, and produce a test result.

2. The apparatus according to claim 1, further comprising a display device connected to the host computer for displaying the test result.

3. The apparatus according to claim 1, wherein the digital signal input interface of the audio analyzer is connected with a universal serial bus (USB) interface of the client computer via a second sound card.

4. The apparatus according to claim 3, wherein the second sound card is configured for converting the first digital audio signals into second digital audio signals receivable by the audio analyzer, and transmitting the second digital audio signals to the digital signal input interface of the audio analyzer.

5. The apparatus according to claim 1, wherein the analog signal output interface of the audio analyzer is connected to a digital audio signal output interface of the client computer directly.

6. A method for playback test of an audio device, the method comprising the steps of:
controlling an audio analyzer connected to a host computer to generate analog audio signals at different sampling frequencies, different sampling bit width and different signal amplitude, and controlling the audio analyzer to output the digital audio signals to a client computer connected to the audio analyzer via an analog signal output interface;
receiving the analog audio signals and converting the analog audio signals into first digital audio signals by a first sound card to be tested inside the client computer;
outputting the first digital audio signals to a digital signal input interface of the audio analyzer; and
controlling the audio analyzer to test and analyze the digital signals, received at the digital signal input interface, and producing a test result.

7. The method according to claim 6, wherein the content of testing and analyzing the digital audio signals includes full scale output voltage, frequency response, total harmonic distortion plus noise, dynamic range, signal to noise ratio, channel separation, passband ripple, and interchannel phase delay.

8. The method according to claim 6, wherein the digital signal input interface of the audio analyzer is connected with a universal serial bus (USB) interface of the client computer via a second sound card.

9. The method according to claim 8, further comprising the step of converting the first digital audio signals into second digital audio signals receivable by the audio analyzer, and transmitting the second digital audio signals to the digital signal input interface of the audio analyzer.

10. The method according to claim 6, wherein the analog signal output interface of the audio analyzer is connected to a digital audio signal output interface of the client computer directly.
